(19) United States
(12) Patent Application Publication
(10) Pub. No.: US 2017/0140050 A1
(43) Pub. Date: May 18, 2017

(54) Real-Time Search In a Network Domain

(71) Applicant: CENX, Inc., Ottawa (CA)

(72) Inventors: Eric Duncan Soutar, Ottawa (CA); Andrew Allan Brown, Ottawa (CA)

(21) Appl. No.: 14/942,272

(22) Filed: Nov. 16, 2015

(51) Int. Cl. G06F 17/30; H04L 29/06; H04L 29/08

(52) U.S. Cl. CPC G06F 17/30867; H04L 67/1097; H04L 67/42; G06F 17/30554; G06F 17/30011

(57) ABSTRACT

Disclosed herein are embodiments for real-time search in a network domain. An embodiment operates by receiving search input via a user interface, the search input corresponding to a search for one or more network documents of a data store. The one or more network documents include two or more different representations of a client communications network. One or more networking terms that include the search input are identified. Search results responsive to the search input are provided.

### BACKGROUND

Field

The field is related search and network technologies.

Background

Network data usage has increased rapidly in recent years. Network service users demand higher bandwidth with better quality and secure connectivity. Modern network service providers operate local, regional, and nationwide networks to provide connectivity to users. These networks are built with a variety of equipment to perform various tasks, and such equipment may be manufactured by multiple vendors. Each piece of equipment may be complex enough to handle hundreds to thousands of simultaneous connections, and different pieces of equipment may be widely dispersed across a region. Wireless base stations, for example, may be geographically distributed across a city to optimize coverage and efficiency.

To meet user demand, network operators are investing heavily in network infrastructure and new applications to increase network capacity and maintain consistent performance. Today's network infrastructure is evolving faster than ever due to significant innovations in high-speed mobile broadband, cloud-based applications, network functions virtualization (NFV), software-defined networking (SDN), carrier Ethernet, and IP virtual private networks (VPNs). These advances in network technologies are impacting the underlying networks upon all network service providers. Service providers introduce 4G technology, cloud-based infrastructure, NFV, and SDN to better scale and manage their services and infrastructure assets. These dynamics have been fueling a transformation from TDM-based bandwidth services to carrier Ethernet and layer 3 IP services such as IP-VPN and Multiprotocol Label Switching (MPLS) connectivity.

For example, NFV and SDN are two emerging technologies that are expanding the transformation of service provider network services. NFV uses virtualization technologies to design, deploy, and manage network services. NFV decouples the network functions, such as firewall, network address translation (NAT), domain name service (DNS), load balancing, WAN optimization, and intrusion detection, from dedicated hardware appliances so that these network functions can execute in software and processes running within virtual machines. SDN separates control and forwarding functions, centralizes management, and programs network behavior using well-defined interfaces. SDN enables network control to become directly programmable, and the underlying infrastructure can be abstracted from applications and network services. With SDN and NFV, service providers can provide differentiated, revenue-generating service offerings to their end customers while reducing operational costs and simplifying network management.

Another extension is Voice over Long Term Evolution (VoLTE), which allows service providers to offer voice communication services over their high speed 4G LTE infrastructures that was traditionally used for data only, maximizing the value of service providers' investment. VoLTE is moving into mainstream production globally. As service providers are deploying VoLTE, service providers are also leveraging NFV technology to build out their VoLTE infrastructure more efficiently and cost effectively.

These disruptive technologies lead to significant challenges for network service providers because network transformation is complex and labor-intensive. Service providers need to build out network infrastructure leveraging emerging technologies while also operating within their existing infrastructure and maintaining the high quality of service end users expect.

Accommodating new technologies can increase the complexity of network operations. The increased operational complexity may include, for example, lengthy circuit turn-up time, inventory inaccuracy, challenges in accurately resolving faults, or unreliable performance for high value applications such as video and VoLTE. To handle this complexity, today's mobile, wire line, and cloud data center service providers are looking for new ways to design, implement, and manage their network infrastructures.

Conventional operations support systems (OSSs) can no longer simply be tweaked to support end-to-end management of increasingly complex network infrastructures. Conventional OSSs are systems used by service providers to manage their networks (e.g., telephone networks or data networks). Conventional OSSs provide functionality including network inventory, fault management, service provisioning, and network configuration. Conventional OSSs often utilize well-known, existing network management models to manage their network elements in service providers' network infrastructures. Well-known examples of network management models include FCAPS and OAMPT.

FCAPS stands for fault, configuration, accounting, performance, and security, which are categories that define network management tasks. FCAPS is the International Organization for Standardization (ISO) Telecommunications Management Network model and framework for network management. Fault management is related to identifying, correcting, and logging network problems (i.e., faults) to minimize network downtime. Configuration management is related to gathering configurations from network devices and applying configurations to network devices. Configurations may be hardware and programming changes, including the addition, deletion, or modification of network equipment and programs in the communications network. Accounting management focuses on gathering network usage statistics so that individual users, departments, or business units can be properly billed for accounting purposes. Performance management is concerned with managing the overall performance of the network and ensuring that network performance remains at acceptable levels. Security management is related to protecting the network against unauthorized access.

Another well-known network management model is OAMPT. OAMPT stands for operations, administration, maintenance, provisioning, and trouble shooting. OAMPT describes five types of network management tasks: operational management, administration, maintenance, provisioning, and troubleshooting. Operational management is concerned with day-to-day normal network operations. Administration includes support procedures for day-to-day operations. The support procedures can include, for example but not limited to, common passwords, equipment and tools access, and customer service report. Maintenance focuses on configuration and hardware changes in response to system deterioration. These changes include, for example but not limited to, scheduling service provider maintenance, standard network equipment configuration changes, routine equipment checks, hardware changes, and software/firmware upgrades. Provisioning is related to configurations that add, update, and remove network hardware equipment and network services. Troubleshooting involves diagnosis of network failures.

Regardless, the existing models of the conventional OSSs do not accommodate the needs of today's complex networks. There is little abstraction to hide the complexity, and each OSS needs to hold the detailed physical inventory and logical service topology in every domain across all legacy and new technologies.

These complex networks though are critical to many companies. Without intranet, Internet, or other communications, a business could not operate, could not communicate with clients, and would likely fail in today's economy. As such, maintaining and improving these networks is an important task for which the most up-to-date information possible is helpful, if not required. Unfortunately, conventional search engines are ill equipped to access or provide this information.

### SUMMARY

Systems and methods are disclosed for providing real-time search in a network domain. In an embodiment search input is received via a user interface, the search input corresponding to a search for one or more network documents of a data store. The one or more network documents include two or more different representations of a client communications network. One or more networking terms that include the search input are identified. Search results responsive to the search input are provided.

Further embodiments, features, and advantages, as well the structure and operation of the various embodiments, are described in detail below with reference to accompanying drawings.

### BRIEF DESCRIPTION OF THE DRAWINGS

The accompanying drawings are incorporated herein and form a part of the specification.

FIG. 1 is a block diagram of a system for providing real-time search in a network domain, according to an example embodiment.

FIG. 2 is a block diagram of a system for providing real-time search in a network domain, according to another example embodiment.

FIG. 3 is a flowchart for a method for providing real-time search in a network domain, according to an embodiment.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system and method embodiments, and/or combinations and sub-combinations thereof, for providing real-time search in a network domain.

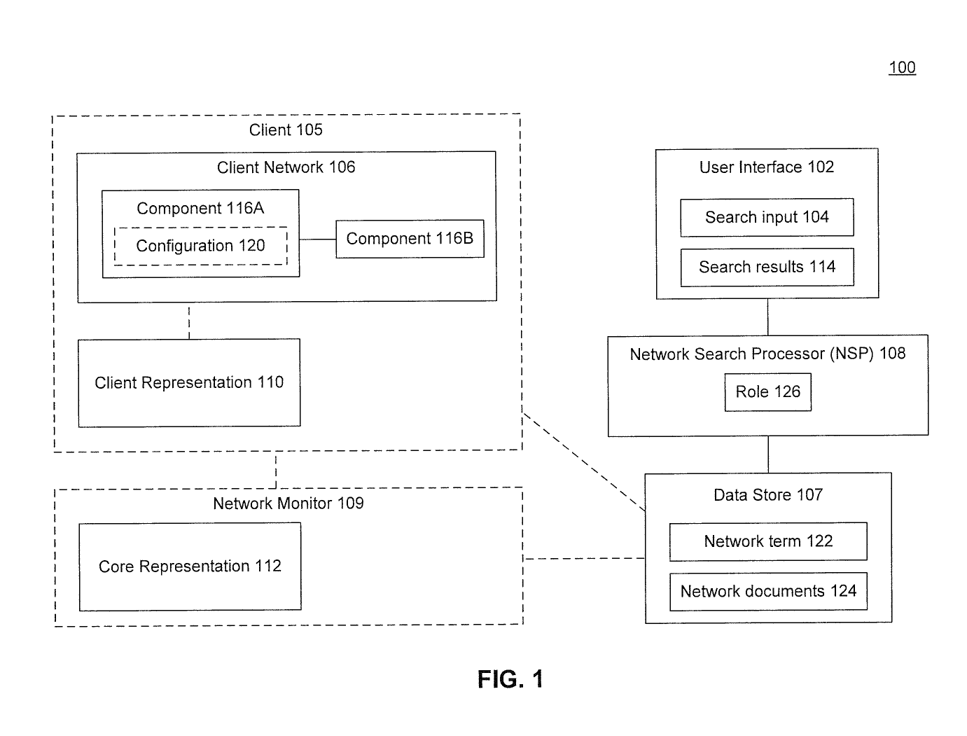

FIG. 1 is a block diagram of a system 100 for providing real-time search in a network domain, according to an example embodiment. System 100 provides search capabilities associated with a client network 106 and bridges a gap between two differing network representations 110 and 112 used to represent client network 106.

A user interface 102 may receive search input 104 requesting information about client network 106. Search input 104 may be a request for any information about client network 106, including for example, IP (internet protocol) address lookups, usage information, connectivity issues, equipment or other technical configuration details, and current or past system states or status updates. User interface 102 may a graphical user interface (GUI) displayed on a mobile device or other computer.

A network search processor (NSP) 108 may receive search input 104 to produce search results 114. NSP 104 may search through documents corresponding to client representation 110 and core representation 112 of client network 106 as stored in a data store 107, based on the requested search input 104, to provide search results 114. Search results 114 may include real-time suggested search phrases including network terms 112 and/or one or more network documents 124 retrieved or generated from representations 110 and/or 112 that correspond or are otherwise scored as being related to search input 104.

Client network 106 may be a communications network used to support business functions of a client 105. Client 105 may be any business, government, or other entity that relies on client network 106 for at least a portion of its operations. Client network 106 may provide Internet, intranet, phone, or other communications and/or connectivity services both within client 105 and/or between client 105 and its own customers, agents, or other partners using one or more network or communication components 116.

In an embodiment, a network monitor 109 may monitor, maintain, or improve client network 106 on behalf of and/or in conjunction with client 105. For example, client 105 may have its own in-house staff or administrators that serve as a network monitor 109 to maintain, monitor, or otherwise manage client network 106. However, client 105 may alternatively, or in addition, contract with a network monitor 109 to assist with client network 106 management functions. These network management functions may include monitoring, changing, maintaining, and improving client network 106. To enable network monitor 109 to fulfill its duties, network monitor 109 may receive information or updates from client 105 and/or client network 106 with regard to the state and/or status of client network 106 and its various components 116.

In an embodiment, network monitor 109 may be a network monitoring and/or administration company that has many different clients 105, each with its own specialized or specially configured client network(s) 106. As such, network monitor 109 may have its own core representation 112 or schema with regard to how it models or views each client network 106.

Most client networks 106 will have overlapping features or similarities common amongst multiple networks 106. Theses overlapping features may include the types of components 116 comprising each network 106, interfaces or standards by which the components communicate with one another including both wired and wireless communications, or other similarities. Example components 116 that may be common amongst multiples networks may include servers, routers, switches, terminals, and/or common software components (such as server or database software) as well. These similarities or commonalties may be modeled via core representation 112.

However different client networks 106 may be specialized to perform or support different or specialized functions or business goals. As such, the various components 116 in each client network 106 may have its own unique configuration of 120, specific to that component 116, client network 106, and/or client 105.

Configuration 120 may include hardware and/or software configurations, and may include the configuration data regarding component 116 itself. Example configurations 120 include how much memory, with which other components 116, using what network or communication standards, a speed of communication, installed software, a required uptime, download or upload speeds, or any other number of configuration details that may be associated with one or more components 116. While some of these configuration settings 120 may be captured within core representation 112, a client 105 may have its own terminology and/or other specialized ways of representing or referring to its client network 106 that may not be captured or adequately captured by core representation 112, which is designed to apply to networks generally across clients 105.

As noted above, client network 106 may be specially configured depending on the client 105 and/or the business process or objective it is designed or intended to fulfill. For example, a first client network 106 may be configured for providing cell phone communications services between cell phone users and cell towers. A second client network 106 (not shown) may have its primary function of providing data center support, while a third client network 106 may be specially configured and geared towards providing high-speed communications for financial transactions, such as stock market trading. These various client networks 106 may be associated with one or more clients 105. For example, a single client 105 may have multiple specialized client networks 106.

As such, a client 105 may have its own client representation 110 specific to its own client network 106, using its own internal terminology, documents, reporting, or other ways of representing a model, schema, and/or status of client network 106. However, having access to this information from client representation 110 may enable network monitor 109 to provide a fuller view or model of client network 106, support client 106, and maintain, manage, or improve the functionality of client network 106.

In an embodiment, a gap may exist between a client representation 110 of its own client network 106, and core representation 112 of network monitor 109. For example, the gap may include different terminology used to describe the same or similar components, whereby client representation 110 may include specific terminology for client network 106, and core representation 112 may include more general terminology that may be used across different client networks 106. NSP 108 bridges this gap between client representation 110 and core representation 112, and enables a user to receive or search based on a full and complete view of client network 106 across both representations 110, 112.

The gap may be any difference(s) that exist between client representation 110 and core representation 112 of client network 106. As noted above, the gap may be in terminology used, configuration settings, specialized components 116, or any other features used or configured for client network 106 that are not used on or more other client networks 106 associated with network monitor 109, NSP 108, data store 107, or otherwise represented by an embodiment of core representation 112.

As noted above, user interface 102 may receive search input 104 regarding client network 106. Search input 104 may include an alpha-numeric word-string, a specialized network phrase (such as an IP address or telephone number), an image, or any other searchable input. Search input 104 can be entered through user selections or input into a search box, control panel, and/or other type of input in user interface 102.

Search input 104 may be received and/or detected by NSP 108. NSP 108 may parse search input 104 to determine if search input 104 is a specialized network phrase that needs specialized lexical analysis. Unlike natural language, terminology within the network domain may have its own unique structure and significance. For example, NSP 108 may be able to detect specialized networking terminology such as internet protocol (IP) addresses that are provided via search input 104. NSP 108 may operate across one or more processors, or in a network or cloud type architecture. NSP 108 may be arranged to be able to communicate with one or more components of client network 106 and one or more devices of network monitor 109 (which may operate on different or the same processors as NSP 108).

In an embodiment, NSP 108 may determine when specialized network terminology is being used because it is being entered into a specific field of user interface 102. For example, there may be an IP address search field, phone number search field, or other network specific fields. In another embodiment, a user may provide a special tag or string indicating the type of data being provided (e.g., #IP, #phnum, etc.). In another embodiment, through its own string parsing routine, NSP 108 may identify different types of network specific terminology and may be able to determine the difference between a string of numbers, an IP address, and a phone number, based on known formats or stored lists of known terms for the different types of information.

An IP address includes a string of numbers separated by a number of periods. In the networking domain, the numbers of an IP address and the period have special significance compared to the numbers used in a word-based sentence and the period at the end of the sentence. As such, NSP 108 may process the entering of an IP address differently than if it receives a normal text-based search input 104. NSP 108 may be able to differentiate between search input 104 that includes text-based search phrases and specialized network domain phrases (such as an IP address, MAC (media access control) address, phone number, component 116 serial number, networking standard, or domain name). In an embodiment, NSP 108 may perform different lexical analysis based on the differences.

Other examples of specialized networking terminology, for which NSP 108 may have its own specialized lexical analysis (that is different from natural language processing), include, but are not limited to, IPv4/v6 address matching, site identifiers (such as common language location identifier (CLLI) codes), and equipment names or models.

In an embodiment, NSP 108 may return real-time search suggestions as the user is typing search input 104 into a search box of user interface 102. The suggestions may be filtered based on the user, one or more of the representations 110, 112, and/or client network 106 as provided by data store 107.

The real-time search suggestions provided by NSP 108 may provide real-time status information about client network 106. For example, rather than receiving batch updates of information about client network 106 on a weekly or bi-weekly basis, data store 107 may have access to or receive real-time status information about client network 106. Then, for example, when a search input 104 is received, NSP 108 may do a search for and return real-time results based on client representation 110 and/or core representation 112.

Data store 107 may be a database, processor, server farm, or any other computing devices that receive or are able to retrieve or request information about client network 106. For example, when a status of a component 116 changes (e.g., goes offline/online) this information may be provided to data store 107, and can be provided to NSP 108 for a relevant search. Or, for example, if a search for a status of a component is received as search input 104, data store 107 may be able to query or retrieve status information regarding the identified component(s) 116 from client representation 110, core representation 112, or client network 106 itself.

In an embodiment, search input 104 is a phrase or other input related to finding a status or other information about client network 106. NSP 108 may identify whether search input 104 is directed towards client representation 110, core representation 112, or client network 106 generally (e.g., both representations 110, 112). NSP 108 may then search the relevant representation(s) 110, 112 to produce search results 114.

In an embodiment, which representation 110, 112 is searched and/or how search results 114 are identified may be sorted or otherwise weighted based on a role 126 associated with a user performing the search (i.e., requesting search results 114 or providing search input 104). For example, if role 126 indicates the user is associated with client 105, then greater weight may be provided to results from client representation 110, and vice versa if role 126 is associated with network monitor 109. In an embodiment, a search by a role 126 associated with an employee of client 105 will be limited to only client representation 110.

Role 126 may correspond to a user's responsibilities or functions in an organization (e.g., client 105 or network monitor 109) or with regard to client network 106. Example roles 126 include database administrator, network administrator, software developer, vice president, and guest. These roles 126 may exist on either the client 105 side or the network monitor 109 side. NSP 108 may track previous searches, selections, and/or other activity performed by a particular user or across a number of users in the same or similar role 126 to provide, filter, and/or weigh search results 114, and provide the most relevant search results 114 to the user via user interface 102.

In an embodiment, role 126 may include location information. As such, search results 114 that include network components or equipment may be scored or weighted higher based on their network and/or geospatial proximity to the user.

Search results 114 may include network terms 122 and/or network documents 124 from across one or more representations 110, 112. As noted above, each representation 110, 112 may have its own terms 122 and its own set of documents 124.

In an embodiment, network documents 124 within a representation 110, 112 may be organized into one or more collections or group of related or indexed documents. Each collection may be arranged with specific subject-type documents. For example, a first collection of documents may include an inventory of network components 116, while a second collection may include documents related to network events such as receipt/transmittal of files, or network alarms, failures, or service outages. A third collection may be related to network access, indicating who has accessed or attempted to access the networks, over which ports, from which IP addresses, and what functions they performed or attempted to perform.

In an embodiment, the terms of core representation 112 may be more general and applicable to a wide variety of networks, such as routers, switches, towers, terminals and the like. By contrast, the terms of client representation 110 may be company or client-specific and may include internal client references to equipment, processes, or other network associated functionality. For example, in a financial transactions network context of a client representation 110, a particular set of terminals may be referred to a “trade buffer,” where to-be-executed trades are stored and ordered based on priority prior to execution. Meanwhile, core representation 112 may not have a term to describe similar equipment functionality, or may refer to it simply as a server or terminal, depending on which component 116 performs the functionality. In an embodiment, NSP 108 may include with search results 114 a translation between client terms and core terms.

In an embodiment, client representation 110 may include a set of client documents that are used to indicate a status or model of client network 106, and core representation 112 may include a set of core documents that are used to indicate the status or model of client network 106 as well. Similar to the terminology used by each representation, the documents of each representation may be geared towards either network-specific descriptions (for client representation 110) or broader network related status documents that could be applicable across a larger number or different types of networks (for core and/or client representation 110, 112).

In an embodiment, core representation 112 may include specific documents, reports, or files requested by network monitor 109 to assemble and maintain core representation 112. Or, for example, may include specially generated information, diagrams, documents, and files generated by network monitor 109 specifically for monitoring client network 106.

NSP 108 provides for functionality whereby users in different roles 126 may obtain real-time search results 114 regarding a status of client network 106, and may leverage the information that exists across two or more different network schemas or network models and provided by representations 110, 112.

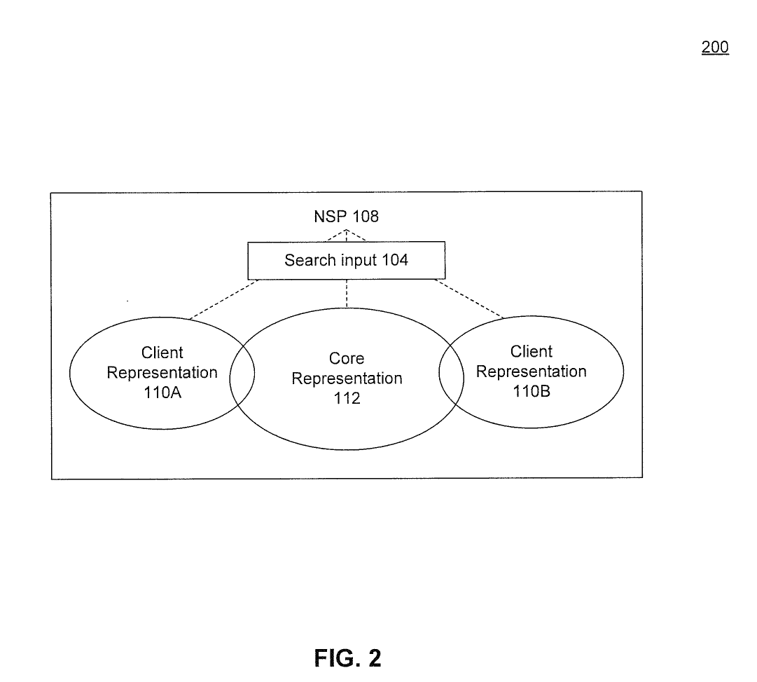

FIG. 2 is a block diagram of a system 200 for providing real-time search in a network domain, according to another example embodiment. In the example of FIG. 2, a network search processor (NSP) 108 is shown, in which a search input 104 is received.

Based on which client 105 the search input 104 or role 126 of a user requesting the search is associated with, NSP 108 may search client representation 110A, core representation 112, or client representation 110B. In an embodiment, both core representation 112 and one or more of the client representations 110A, 110B may include terminology and/or documents that overlap.

As shown, NSP 108 may be a single system deployed to monitor a plurality of client networks 106 represented by a number of varying client representations 110A, 110B and associated with different clients 105. Depending on a role 126 of a user, the search results 114 may be extracted or determined from only the associated client representation 110, the overlap of between core representation 112 and the associated client representation 110, or from only the core representation 112 of a related client network 106.

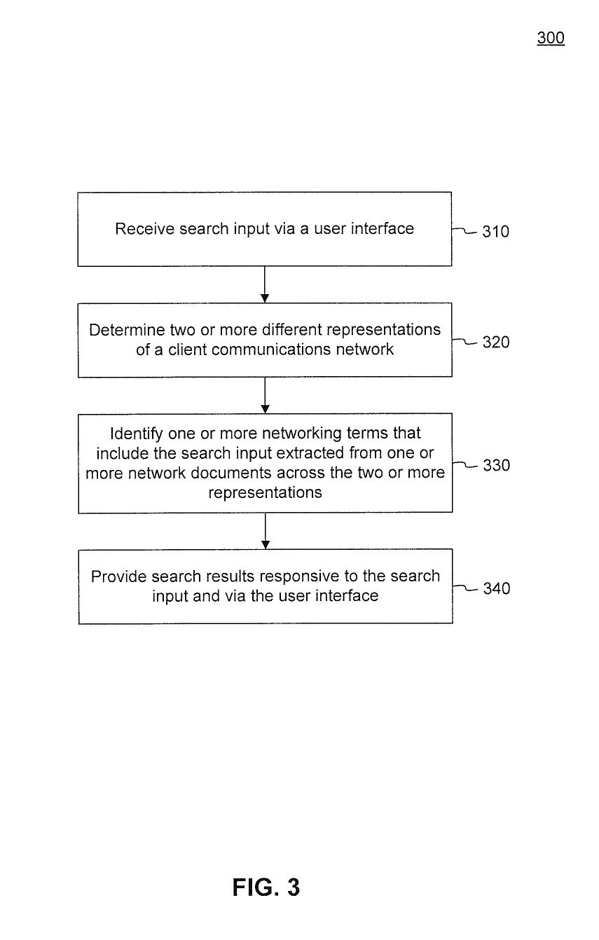

FIG. 3 is a flowchart for a method 300 for providing real-time search in a network domain, according to an embodiment. Method 300 can be performed by processing logic that can comprise hardware (e.g., circuitry, dedicated logic, programmable logic, microcode, etc.), software (e.g., instructions run on a processing device), or a combination thereof. In a further embodiment not intended to be limiting, method 300 can be carried out on system 100.

In step 310, search input is received via a user interface. For example, user interface 102 may receive search input 104 from one or more users from client 105 and/or network monitor 109. Search input 104 may request information regarding a status of client network 106.

In step 320, two or more different representations of a client communications network are determined. For example, NSP 108, in fulfilling search query or search input 104 may search two different representations 110, 112 used to represent or model client network 106. Each representation 110, 112 may have its own terminology and/or documentation associated with its model or view of client network 106.

In step 330, one or more networking terms that include the search input extracted from one or more network documents across the two or more representations are identified. For example, based on a role 126 of a user and/or the search input 104, NSP 108 may retrieve search results from client representation 110, core representation 112, or both.

In step 340, search results responsive to the search input and via the user interface are provided. For example, NSP 108 may weigh, score, and/or organize search results 114 based on role 126. Search results 114 may then be graphically displayed for a user via user interface 102. Search results 114 may include suggested or predictive search input 104 including network terms 122 and/or one or more network documents 124, including links thereto.

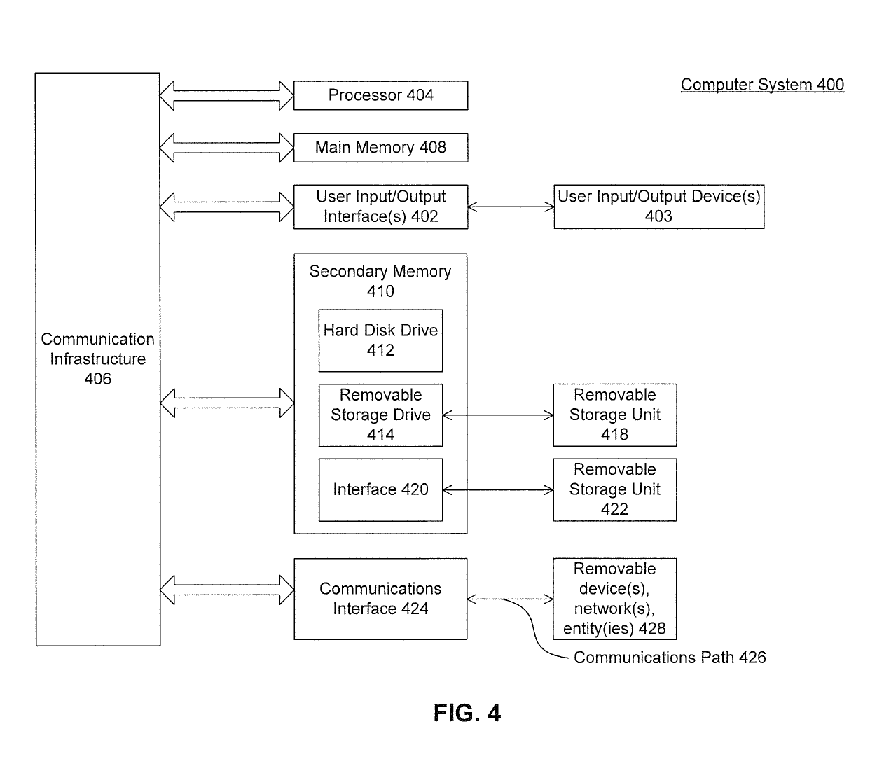

FIG. 4 is an example computer system 400 useful for implementing various embodiments. Various embodiments of system 100 and method 300 can be implemented, for example, using one or more well-known computer systems, such as computer system 400. Computer system 400 can be any well-known computer capable of performing the functions described herein. In an embodiment, components 116 of client network 106, NSP 108, and user interface 102 may operate on or across one or more devices with one or more features similar to computer system 400. For example, client network 106 may include a server farm or other cluster of computers that are communicatively coupled to each other, and may be located across one or more geographic regions.

Computer system 400 includes one or more processors (also called central processing units, or CPUs), such as a processor 404. Processor 404 is connected to a communication infrastructure or bus 406.

One or more processors 404 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 also includes user input/output device(s) 403, such as monitors, keyboards, pointing devices, etc., that communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 4. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method, comprising:
receiving search input via a user interface, the search input corresponding to a search for one or more network documents of a data store;
determining with at least one processor that the one or more network documents include two or more different representations of a client communications network including both a core representation indicating network components that are common across two or more networks including the client communications network, and a client-specific representation indicating configuration details of the network components as implemented in the client communications network, wherein each representation includes one or more features not included in the other representation;
identifying with at least one processor one or more networking terms that include the search input, wherein the networking terms are extracted from the one or more network documents across the two or more representations; and
providing search results responsive to the search input, the search results including identified one or more networking terms or the one or more network documents from which the one or more networking terms were extracted.

2. The method of claim 1, wherein the one or more network documents include real-time data received about the client communications network.

3. The method of claim 2, wherein the search input corresponds to a search for real-time data being received about the client communications network during the receiving of the search input, and wherein the search results include the received during the receiving of the search input.

4. The method of claim 1, wherein search results are updated, without user interaction, based on the receipt of additional real-time data about the client communications network that is relevant to the search input.

5. The method of claim 1, further comprising:
receiving a role associated with a user from whom the search input is received, the role corresponding to responsibilities of the user in managing the client communications network; and
wherein the identifying comprises identifying the one or more networking terms relevant to the role, wherein the one or more networking terms relevant to the role are associated with a previous search input by a user in the role.

6. The method of claim 5,
wherein the receiving comprises receiving a first search input from a first user and a second search input from a second user, the first search input and the second search input being the same, wherein each user is associated with a different role; and
wherein the providing comprises providing a first search result to the first user, and providing a second search result to a second user, wherein the first search result differs from the second search result based on the different roles.

7. The method of claim 1, wherein the search input includes a time element requesting a state of the client communications network at a specified time, and wherein the search results include pieces of information from both representations of the client network at the specified time element.

8. The method of claim 1, wherein the identifying comprises identifying that the search input includes an internet protocol (IP) address and a language-based search string, wherein a processing of the IP address in identifying the one or more network documents varies from a processing of the language-based search string in identifying the one or more network documents, wherein the variation is based on two different interpretations of an overlapping character in both the IP address and the language-based search string.

9. A system, comprising:
a memory; and
at least one processor coupled to the memory and configured to:
receive search input via a user interface, the search input corresponding to a search for one or more network documents of a data store;
determine that the one or more network documents include two or more different representations of a client communications network including both a core representation indicating network components that are common across two or more networks including the client communications network, and a client-specific representation indicating configuration details of the network components as implemented in the client communications network, wherein each representation includes one or more features not included in the other representation;
identify one or more networking terms that include the search input, wherein the networking terms are extracted from the one or more network documents across the two or more representations; and
provide search results responsive to the search input, the search results including identified one or more networking terms or the one or more network documents from which the one or more networking terms were extracted.

10. The system of claim 9, wherein the one or more network documents include real-time data received about the client communications network.

11. The system of claim 10, wherein the search input corresponds to a search for real-time data being received about the client communications network during the receiving of the search input, and wherein the search results include the received during the receiving of the search input.

12. The system of claim 9, wherein search results are updated, without user interaction, based on the receipt of additional real-time data about the client communications network that is relevant to the search input.

13. The system of claim 9, wherein the processor is further configured to:
receive a role associated with a user from whom the search input is received, the role corresponding to responsibilities of the user in managing the client communications network; and
wherein the identifying by the processor comprises identifying the one or more networking terms relevant to the role, wherein the one or more networking terms relevant to the role are associated with a previous search input by a user in the role.

14. The system of claim 13, wherein
wherein the receiving by the processor comprises receiving a first search input from a first user and a second search input from a second user, the first search input and the second search input being the same, wherein each user is associated with a different role; and
wherein the providing by the processor comprises providing a first search result to the first user, and providing a second search result to a second user, wherein the first search result differs from the second search result based on the different roles.

15. The system of claim 8, wherein the search input includes a time element requesting a state of the client communications network at a specified time, and wherein the search results include pieces of information from both representations of the client network at the specified time element.

16. The system of claim 8, wherein the identifying comprises identifying that the search input includes an internet protocol (IP) address and a language-based search string, wherein a processing of the IP address in identifying the one or more network documents varies from a processing of the language-based search string in identifying the one or more network documents, wherein the variation is based on two different interpretations of an overlapping character in both the IP address and the language-based search string.

17. A tangible computer-readable device having instructions stored thereon that, when executed by at least one computing device, causes the at least one computing device to perform operations comprising:
receiving search input via a user interface, the search input corresponding to a search for one or more network documents of a data store;
determining that the one or more network documents include two or more different representations of a client communications network including both a core representation indicating network components that are common across two or more networks including the client communications network, and a client-specific representation indicating configuration details of the network components as implemented in the client communications network, wherein each representation includes one or more features not included in the other representation;
identifying one or more networking terms that include the search input, wherein the networking terms are extracted from the one or more network documents across the two or more representations; and
providing search results responsive to the search input, the search results including identified one or more networking terms or the one or more network documents from which the one or more networking terms were extracted.
